(19) United States
(12) Patent Application Publication
(10) Pub. No.: US 2018/0110589 A1
(43) Pub. Date: Apr. 26, 2018

(54) ORTHODONTIC PROCESS WITH DYNAMIC PLANNING AND INCREMENTAL IMPLEMENTATION

(71) Applicant: Fei Gao, Cypress, CA (US)

(72) Inventor: Fei Gao, Cypress, CA (US)

(21) Appl. No.: 15/334,499

(22) Filed: Oct. 26, 2016

(51) Int. Cl. A61C 7/00; A61C 7/08; A61C 9/00; A61C 13/00

(52) U.S. Cl. CPC A61C 7/002; A61C 13/0004; A61C 9/0053; A61C 7/08

(57) ABSTRACT

The present invention provides an orthodontic process phased into two or more sub-processes for repositioning a patient's teeth. In each sub-process, a complete treatment plan is established, but not all (i.e. only some) appliances in the plan are fabricated to move the teeth, out of the expectation that teeth movement may not completely follow the full course as planned. The entire orthodontic process is thus featured with dynamic planning and incremental implementation of the plans, to address ever-changing treatment profile.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present invention generally relates to the field of orthodontics. More particularly, the present invention is related to a method and system for incrementally moving teeth from an initial tooth arrangement to a final tooth arrangement.

### BACKGROUND OF THE INVENTION

Orthodontics is a specialty that deals primarily with the diagnosis, prevention and correction of malpositioned teeth and the jaws. Conventionally, repositioning teeth for aesthetic or other reasons is accomplished by wearing braces including appliances such as brackets, archwires, ligatures, and O-rings. Typically, X-rays and photographs of the patient's teeth and jaw structure are taken first. An alginate mold of the patient's teeth may be made for the orthodontist to use in conjunction with the X-rays and photographs to formulate a treatment strategy. The orthodontist then typically schedules one or more appointments during which braces will be attached to the patient's teeth.

To attach the braces, the teeth surfaces intended for the brackets and bands to bond onto are treated with a weak acid to optimize their adhesion properties. The brackets and bands serve as anchors for other appliances to be added later. After the acid step, the brackets and bands are cemented to the patient's teeth using a bonding material. After the cement is set, force-inducing appliances such as archwire are added. The archwire is resilient, and in ligation, it is attached to slots in the brackets. The archwire links the brackets together and exerts forces on them to move the teeth over time. Ligatures such as twisted wires or plastics such as elastomeric O-rings are commonly used to reinforce attachment of the archwire to the brackets. The patient's braces will later be adjusted by installing a different archwire having different force-inducing properties or by replacing or tightening existing ligatures.

An alternative method for repositioning teeth is using clear aligners, which are transparent devices designed to adjust teeth incrementally. Clear-aligner treatment involves an orthodontist taking a mold of the patient's teeth, which is used to create a digital tooth scan. Aided by computer modeling and simulating, the orthodontist can plan a series of intermediate tooth arrangements between the current tooth arrangement and desired final tooth arrangement, and aligners are then created for all intermediate tooth arrangements. For example, U.S. Pat. No. 6,217,325 to Chishti et al. discloses a method to make orthodontic aligners. It uses CAD technology to virtually plan the desired tooth arrangements, generates stage models to reflect the gradual repositions of teeth, then makes the staged models, and uses certain manufacturing approaches to make negative models out of the staged models. Those negative models are the orthodontic aligners. In a nutshell, this procedure includes digital model acquisition using scanners, treatment planning and model generation with computer systems, model manufacturing and the aligner fabrication. Ideally, a patient wears each aligner for about two weeks or until the pressure of each appliance on the teeth can no longer be felt. At that point, the patient replaces the current adjustment aligner with next adjustment aligner in the series until no more aligners remain.

During the treatment, however, a patient may forget to wear the aligners as regularly as required by the dentist, causing the treatment to stray from the prescribed course. The initial design of the aligners or the planned tooth adjustment paths may become practically impossible. As a result, one or more aligners may not properly fit and the dentist may have to start the process again (“re-start”) by taking another impression of the patient's teeth so that a new series of incremental position adjustment appliances can be electronically generated and ultimately manufactured to a new prescribed tooth arrangement.

U.S. Pat. No. 8,075,306 to Kitching et al. discloses an approach to cope with the “re-start”. A procedural feature of the approach is to generate one or more corrected stage models so that the treatment course can continue with the prefabricated aligners. The method includes the steps of receiving an un-segmented current teeth image representing a patient's teeth after an orthodontic treatment plan has begun and before the plan ends for the patient; matching a previously segmented teeth model with the current teeth image; and generating at least one corrective stage to define an intermediate tooth arrangement, wherein the at least one corrective stage repositions a digital teeth image so that a prescribed tooth arrangement of the previously segmented teeth model can be used”.

One of the major reason to perform this corrective process is that the treatment planning to segment and move teeth is very tedious. Having some corrective stages will not demand the rework of the entire process.

In prior art, all the aligners are made upfront. A main reason may be that dental offices do not have equipment to make the aligners or it is not affordable. For example, U.S. Pat. No. 6,217,325 teaches that all individual aligners are fabricated at the outset of treatment, and the aligners may thus be provided to the patient as a single package or system. The order in which the aligners are to be used will be clearly marked, (e.g. by sequential numbering) so that the patient can place the aligners over his or her teeth at a frequency prescribed by the orthodontist or other treating professional.

Therefore, there exists a need to make the orthodontic aligners with a better process. Advantageously, the present invention provides solutions to solve these problems. First, this process will gradually make aligners instead making all in the beginning. Secondly, this process will be adaptive and incremental. Once an initial plan is done, one does not need to redo the planning even though during the treatment course one or more aligners will not work as planned. The process can adapt to the actual tooth positions and accomplish the rest of the treatment based on original plan.

### SUMMARY OF THE INVENTION

One aspect of the present invention provides an orthodontic process phased into two or more sub-processes for repositioning a patient's teeth. The process comprises the following phases and steps.

Phase (A) is executing a first sub-process which includes: (A1) scanning the teeth to provide a first geometric model of the teeth; (A2) segmenting the individual teeth to produce a first initial dataset representing a first initial tooth arrangement, wherein tooth segmentation performed in this step is used as the base for subsequent sub-process(es), so that the segmentation(s) in the subsequent sub-process(es) can be executed; (A3) generating a final dataset representing the target tooth arrangement for the entire orthodontic process; (A4) producing a first series of successive intermediate datasets representing a first series of successive intermediate tooth arrangements, wherein said first series of successive intermediate tooth arrangements progressing from said first initial tooth arrangement to said final tooth arrangement, wherein the intermediate datasets and the final dataset each enables the fabrication of a first series of successive corresponding appliances; (A5) fabricating a first beginning portion of the first series of successive appliances; (A6) applying the appliances of said first beginning portion as many as possible on the patient's teeth; and (A7) repositioning the teeth to a first resultant tooth arrangement.

Phase (B) is executing a second sub-process which includes: (B1) scanning the first resultant tooth arrangement to provide a second geometric model of the teeth; (B2) producing a second initial dataset representing a second initial tooth arrangement by registering the scan from (B1) with tooth segmentation from step (A2); (B3) optionally modifying the target tooth arrangement for the entire orthodontic process and registering the tooth arrangement of step (B1) to modified target tooth arrangement, so that the deviation of each tooth's actual position and final position can be calculated; and (B4)-(B7) repeating steps (A4)-(A7) similarly mutatis mutandis.

Phase (C) is optionally executing one or more subsequent sub-processes by repeating the second sub-process similarly mutatis mutandis, until the teeth are repositioned to said target tooth arrangement in step (A3) or any optionally modified target thereafter.

At least one of the above sub-processes can be used to resolve the situation where one or more corresponding appliances in said at least one sub-process cannot be applied to the teeth; the corresponding resultant tooth arrangement is not what the corresponding beginning portion is intended for, and the tooth movements between the resultant tooth arrangement in an sub-process and the desired final tooth arrangement are re-planned based on the actual tooth positons.

Another aspect of the invention provides a distributed CAD/CAM process phased into two or more sub-processes for repositioning a patient's teeth. The process comprises the following phases and steps.

Phase (a) is executing a first sub-process at one facility such as a service provider which includes: (a1) receiving a first geometric model of the teeth generated by scanning the patient's teeth in a dental office; (a2) segmenting the individual teeth to produce a first initial dataset representing a first initial tooth arrangement, wherein tooth segmentation performed in this step is used as the base for subsequent sub-process(es), so that the segmentation(s) in the subsequent sub-process(es) can be executed; (a3) generating a final dataset representing the target tooth arrangement for the entire orthodontic process; (a4) producing a first series of successive intermediate datasets representing a first series of successive intermediate tooth arrangements, wherein said first series of successive intermediate tooth arrangements progressing from said first initial tooth arrangement to said final tooth arrangement, wherein the intermediate datasets and the final dataset each enables the fabrication of a first series of successive corresponding appliances; and (a5) delivering the intermediate datasets and the final dataset back to a second facility such as a dental office.

Phase (b) is executing a second sub-process which includes: (b1) receiving a second geometric model of the teeth generated by scanning the first resultant tooth arrangement in the dental office; (b2) producing a second initial dataset representing a second initial tooth arrangement by registering the scan in (b1) with tooth segmentation from step (a2); (b3) optionally modifying the target tooth arrangement for the entire orthodontic process and registering the tooth arrangement of step b1 to modified target tooth arrangement, so that the deviation of each tooth's actual position and final position can be calculated; and (b4)-(b5) repeating steps (a4)-(a5) similarly mutatis mutandis.

Optional phase (c) is executing one or more subsequent sub-processes by repeating the second sub-process similarly mutatis mutandis, until the teeth are repositioned to said target tooth arrangement in step (a3) or any optionally modified target thereafter.

At least one of the above sub-processes can be used to resolve the situation where one or more corresponding appliances in said at least one sub-process cannot be applied to the teeth in the dental office, the corresponding resultant tooth arrangement is not what the corresponding beginning portion is intended for, and the tooth movements between the resultant tooth arrangement in an sub-process and the desired final tooth arrangement are re-planned based on the actual tooth positons.

Still another aspect of the invention provides a centralized CAD/CAM process phased into two or more sub-processes for repositioning a patient's teeth. The process comprises the following phases and steps.

Phase (I) is executing a first sub-process which includes: (I-1) receiving a first geometric model of the teeth generated by scanning the patient's teeth in a dental office; (I-2) segmenting the individual teeth to produce a first initial dataset representing a first initial tooth arrangement, wherein tooth segmentation performed in this step is used as the base for subsequent sub-process(es), so that the segmentation(s) in the subsequent sub-process(es) can be executed; (I-3) generating a final dataset representing the target tooth arrangement for the entire orthodontic process; (I-4) producing a first series of successive intermediate datasets representing a first series of successive intermediate tooth arrangements, wherein said first series of successive intermediate tooth arrangements progressing from said first initial tooth arrangement to said final tooth arrangement, wherein the intermediate datasets and the final dataset each enables the fabrication of a first series of successive corresponding appliances; and (I-5) fabricating a first beginning portion of the first series of successive appliances, which are delivered to the dental office so that the appliances of said first beginning portion are applied as many as possible on the patient's teeth; and the teeth are repositioned to a first resultant tooth arrangement.

Phase (II) is executing a second sub-process which includes: (II-1) receiving a second geometric model of the teeth generated by scanning the first resultant tooth arrangement in the dental office; (II-2) producing a second initial dataset representing a second initial tooth arrangement by registering the scan in (II-1) with tooth segmentation from step (I-2); (II-3) optionally modifying the target tooth arrangement for the entire orthodontic process and registering the tooth arrangement of step II-1 to modified target tooth arrangement, so that the deviation of each tooth's actual position and final position can be calculated; and (II-4)-(II-5) repeating steps (I-4)-(I-5) similarly mutatis mutandis.

Phase (III) is optionally executing one or more subsequent sub-processes by repeating the second sub-process similarly mutatis mutandis, until the teeth are repositioned to said target tooth arrangement in step (I-3) or any optionally modified target thereafter.

At least one of the above sub-processes can be used to resolve the situation where one or more corresponding appliances in said at least one sub-process cannot be applied to the teeth in the dental office, the corresponding resultant tooth arrangement is not what the corresponding beginning portion is intended for, and the tooth movements between the resultant tooth arrangement in an sub-process and the desired final tooth arrangement are re-planned based on the actual tooth positons.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form in order to avoid unnecessarily obscuring the present invention. Other parts may be omitted or merely suggested.

FIG. 1A is the flow chart of an automatic approach in the orthodontic process in accordance with an exemplary embodiment of the present invention.

FIG. 1B schematically shows a tooth arrangement, a geometric model thereof, and a dataset representing the tooth arrangement in accordance with an exemplary embodiment of the present invention.

FIG. 2 shows the simplified form of tooth arrangement, dataset representing tooth arrangement and appliance in accordance with an exemplary embodiment of the present invention.

FIG. 3 illustrates a final dataset representing the target tooth arrangement for the entire orthodontic process is generated in accordance with an exemplary embodiment of the present invention.

FIG. 4 schematically shows the manner how Steps (A4)-(A7) of the orthodontic process are carried out in accordance with an exemplary embodiment of the present invention.

FIG. 5 demonstrates the manner how Steps (B4)-(B7) of the orthodontic process are carried out in accordance with an exemplary embodiment of the present invention.

FIG. 6 schematically shows the manner how Steps (C4)-(C7) of the orthodontic process are carried out in accordance with an exemplary embodiment of the present invention.

FIG. 7 demonstrates the manner how Steps (D4)-(D7) of the orthodontic process are carried out in accordance with an exemplary embodiment of the present invention.

FIG. 8 schematically shows that the orthodontic process is carried out in two separate facilities (First facility or Facility A, and second facility or Facility 13) in accordance with an exemplary embodiment of the present invention.

FIG. 9 is the flow chart of the initial planning in the orthodontic process in accordance with an exemplary embodiment of the present invention.

FIG. 10 is the flow chart of the incremental planning in the orthodontic process in accordance with an exemplary embodiment of the present invention.

### DETAILED DESCRIPTION OF THE PREFERRED EMBODIMENT

In the following description, for the purposes of explanation, numerous specific details are set forth in order to provide a thorough understanding of the present invention.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

An orthodontic treatment process can be defined in the following. Any tooth arrangement status Tx, either actual or planned, can be represented as a set of tooth models, tx1, tx2, tx3, . . . txm, notated as Tx={tx1, tx2, . . . txm}, assuming there are m teeth. The patient tooth structure for a given status Tx can be represented by a dataset Dx. A treatment is a process to transfer tooth arrangement from Tx1, Tx2, and all the way to a final status Txf, or on the side of digital representation, to transfer D1 to Dx. As a digital representation of Tx, Dx may be (a) as a result of the transformations, and represented as an aggregation of tooth models of {tx1, tx2, . . . txm}, or (b) obtained through imaging or scanning devices, and is segmented into individual tooth models, {tx1, tx2, . . . txm}.

Three aspects are critical to accomplish the transitions of those tooth arrangement status. (1) Segmenting any status Dx (Tx) of the tooth arrangement into {tx1, tx2 . . . , txm}, and Dy(Ty) into {ty1, ty2, . . . tym}. The procedure to perform segmentation is notated as SEG(Tx), SEG(Ty). (2) Establishing the correspondence between {tx1, tx2 . . . , txm} and {ty1, ty2, . . . , tym}, more accurately, between tx1 and ty1, tx2 and ty2, etc. This registration process is notated as REG(Dx1, Dx2). (3) Plan the transformation between two statuses Tx and Ty of the tooth arrangement, or two datasets between Dx and Dy. The algorithm that transfers Tx to Ty is notated as ALG(Tx, Ty).

Given any initial dataset D1 with teeth segmented as status T1, and a final Tx, the goal of orthodontics treatment planning is to create a series of datasets D1, D2, . . . , and Dx. Each of the datasets will be fabricated and called stage models. Aligners can be then made as negative models to cover stage models. Each aligner is made to move the teeth from one arrangement Ti to Tj, while j=i+1.

In an ideal world, the treatment course will follow the transition from T1 to Tx in each of the step, and all the aligners can be made before the treatment starts and apply to the corresponding status of the tooth arrangement.

However, the treatments can actually be deviated from the planned course for various reasons. Assuming a treatment course is planned as Ta, Tb, Tc, . . . , Tx, but the actual treatment cannot be carried out as exactly planned for various reasons. For example, at the ith stage, instead of getting tooth arrangement Ti, one may get Ti′. If a few steps are made to transform the teeth from Ti′ to Ti so that the initial plan can continue, those steps are called corrective steps, as described in U.S. Pat. No. 8,075,306.

In this invention, an incremental approach is introduced, which dynamically plans the treatment course so that the teeth will be moved from Ti′, Tj′, . . . and all the way converge to the desired final status Tx. Any of the intermediate statuses may or may not be same as originally planned as Ta, Tb, . . . Tx.

An objective of this invention is to carry out this planning from Ti′ to Tx automatically or with minimum user interactions by using the results and approach of segmentation, registration and movement planning that have been done. (1) The segmentation of the teeth for status Ti′ should be automatically done. Since Ti′ is not as planned as Ti, one will need acquire the dataset Di′ and perform segmentation of the teeth for this dataset. This segmentation results in {ti′1, ti′2, . . . ti′m}. (2) The correspondence between the individual teeth of Ti′ and the teeth of Tx will be established automatically. (3) The algorithm that initially implements the transformation between Ti(Di) to Tx(Dx) can be automatically applied to the transformation between Ti′ to Tx.

In the following the segmentation and registration process will be elaborated, and an embodiment of the transformation algorithm will be illustrated too.

Typically the digital models are represented as triangulated meshes, which consists of connected triangles and their edges and vertices. The segmented tooth model (tx1, tx2, . . . txm) and the unsegmented model of another status Dj, which is obtained from scanning devices, will have different topologies, meaning the edges, points and faces can be all different even though their geometries are same or similar. There is almost no possibility that the two data sets will have the same topology. U.S. Pat. No. 8,075,306 uses grid to lay on both models to match them. In reality, the creating of such a grid and overlaying it with different models are very complex.

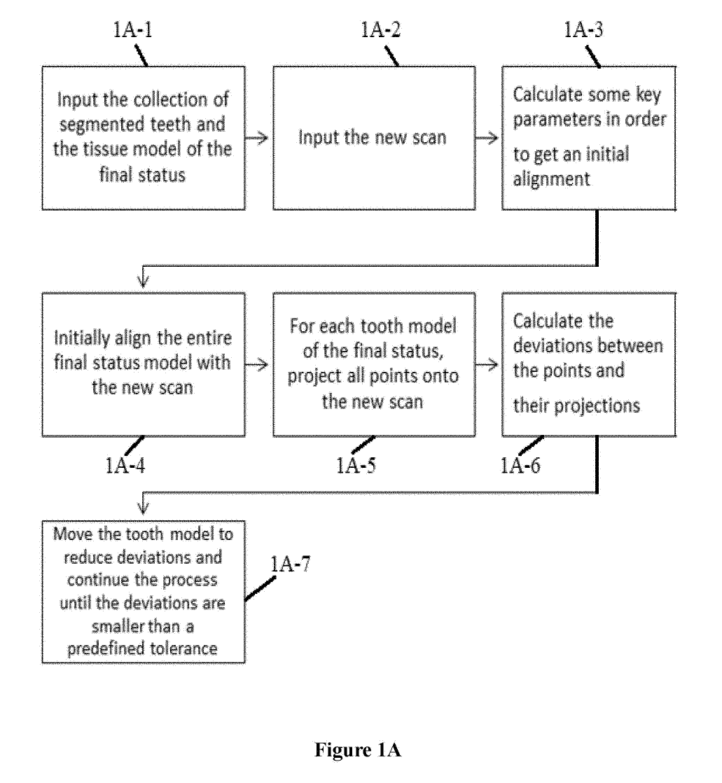

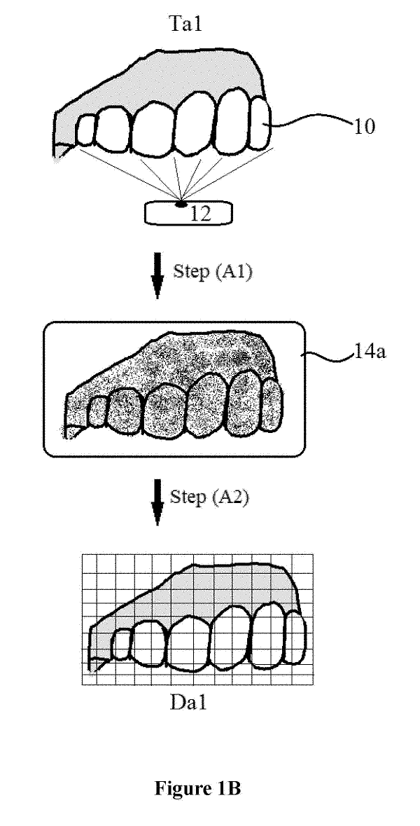

FIG. 1A shows an automatic approach/process, which includes: (1) inputting the collection of segmented teeth tx1, tx2, . . . txm, and the tissue model of the final status; (2) inputting the new scan Di; (3) calculating some key parameters in order to get an initial alignment; (4) initially aligning the entire final status Dx with the new scan Di; and (5) for any of the teeth txm on Dx, projecting all points onto the Di; calculating the deviations between the points of txm and their projections; and moving the tooth model txm to reduce deviations and continuing the process until the deviations are smaller than a predefined tolerance. This is the registration of individual teeth.

If such an automatic approach fails, the computer will prompt the operator to perform manual registration or provide help to the automatic procedure.

Once all the teeth have been registered, the system will use the overlapping of the segmented teeth Tx1, . . . Txm and the unsegmented model Di to label the teeth from the unsegmented model and thus segment all the teeth Ti1, Ti2, . . . Tim.

What is important in this process is that the segmentation that has been done in initial planning is used as a base to segment the teeth on the new dataset Di, and the registration and segmentation are executed in the same time. Once the registration is completed, the segmented teeth can be extracted.

As a result, for each of the tooth such as tooth #2, the system knows the current position (or the “new” initial status) of ti2 and the final position tx2. The algorithm to plan the movements of teeth can now be employed to plan the transformation from ti2 to tx2.

An embodiment is to set a number of steps to move tooth as in this example from ti2 to tx2, and perform a linear interpolation so that tooth 2 will be moved from the ith status to the final xth status. In consequence, all the teeth will be moved gradually and the movements from Di to Dx are thus planned.

The actual process to make orthodontic appliances and carry out the treatment can take advantage of the incremental planning technology. In various embodiments, the orthodontic process of the invention is phased into two or more sub-processes for repositioning a patient's teeth. In the following, four sub-processes, named sequentially as the first, second, third and fourth sub-process, are used as an example to illustrate the invention. It should be appreciated that the entire process may include any number of sub-processes, for example, 2, 3, 5, 6, 10, 15, 20 or even more sub-processes.

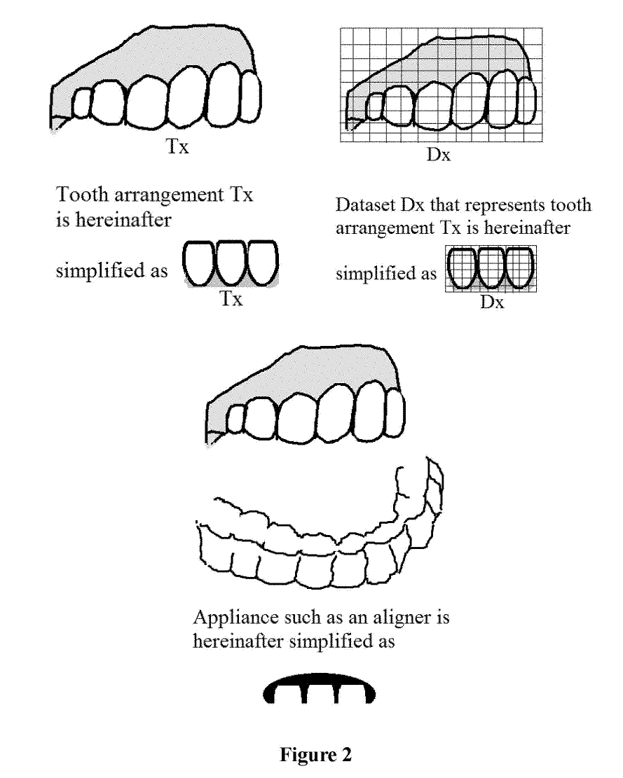

In Phase (A), the first sub-process is executed. The first sub-process includes the following steps. As shown in FIG. 1B, the patient's teeth 10 are in a first initial tooth arrangement Ta1. Step (A1) is scanning the patient's teeth 10 with a scanner 12 to provide a first geometric model 14a of the teeth. In Step (A2), the individual teeth 10 in model 14a are segmented to produce a first initial dataset Da1 representing a first initial tooth arrangement Ta1. For simplicity, FIG. 2 shows that tooth arrangement Tx, dataset Dx representing tooth arrangement Tx, and appliance such as an aligner will be hereinafter represented in simplified forms.

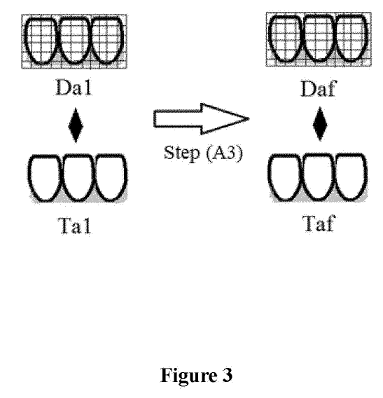

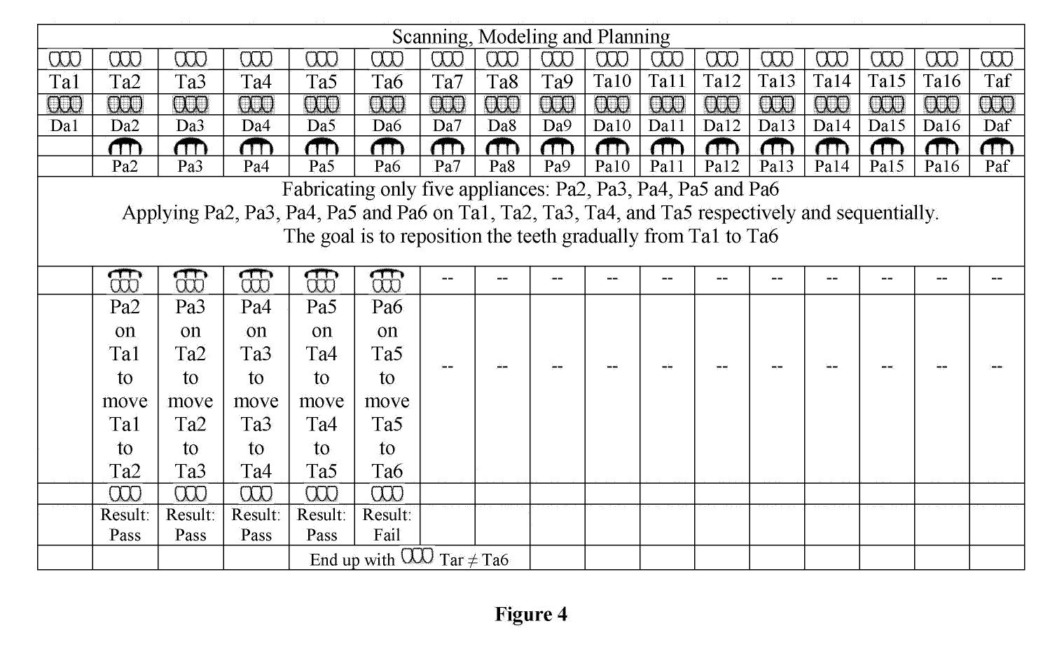

Step (A3) as shown in FIG. 3 is generating a final dataset Daf representing the target tooth arrangement Taf for the entire orthodontic process. Taf is not the target of the first sub-process. As shown in FIG. 4, Step (A4) is producing a first series of successive intermediate datasets (in this example, fifteen datasets Da2˜Da16) representing a first series of successive intermediate tooth arrangements (in this example, fifteen arrangements Ta2˜Ta16). The first series of successive intermediate tooth arrangements are progressing from the first initial tooth arrangement Ta1 to the final tooth arrangement Taf (via Ta2˜Ta16). The intermediate datasets Ta2˜Ta16 and the final dataset Daf each enables the fabrication of a first series of successive corresponding appliances PaS including Pa2˜Pa16 and Paf. However, only a beginning portion Pa(S1) of the first series of successive appliances PaS, for example, only 5 appliances: Pa2, Pa3, Pa4, Pa5 and Pa6 are fabricated in step (A5). Step (A6) is applying or attempting to apply the appliances of the first beginning portion Pa(S1), i.e. Pa2, Pa3, Pa4, Pa5 and Pa6 in this example, as many as possible, on the patient's teeth 10, i.e. Ta1, Ta2, Ta3, Ta4, and Ta5 respectively and sequentially. Specifically, Pa2 on Ta1 is designed to reposition Ta1 to Ta2. Pa3 on Ta2 is designed to reposition Ta2 to Ta3. Pa4 on Ta3 is designed to reposition Ta3 to Ta4. Pa5 on Ta4 is designed to reposition Ta4 to Ta5. Pa6 on Ta5 is designed to reposition Ta5 to Ta6. However, each repositioning is typically performed with a deviation from the ideal plan. As more and more appliances are applied on the teeth, acceptable deviations will be eventually accumulated to an unacceptable level, making one of the appliances unable to be applied to the teeth. For example, Pa5 can barely be applied to Ta4 (with a big but still acceptable accumulated deviations), but Pa6 cannot be applied to Ta5 anymore, since actual Ta5 has an unacceptable accumulated deviation from Ta5 that was ideally planned. As a result the first sub-process repositions the teeth 10 to a first resultant tooth arrangement Tar, as summarized in step (A7).

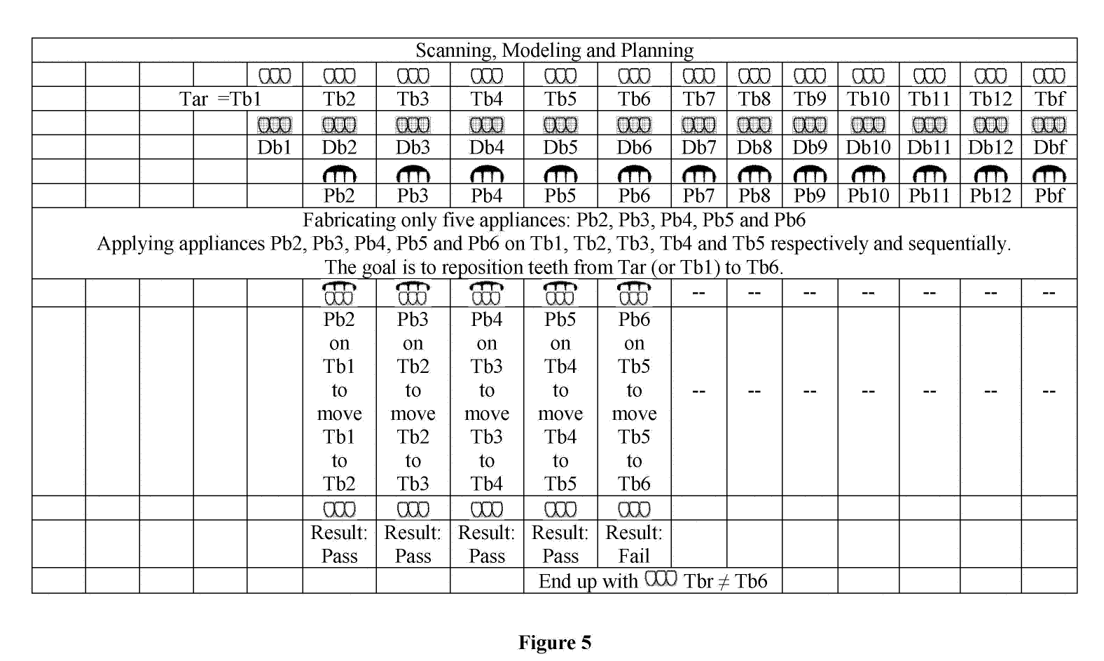

As shown in FIG. 5, the second sub-process is then executed in Phase (B). The second sub-process includes step (B1), i.e. scanning the first resultant tooth arrangement Tar to provide a second geometric model 14b of the teeth. In step (B2), a second initial dataset Db1 representing a second initial tooth arrangement Tb1 may be produced in any manner, but preferably by registering the scan from (B1) with tooth segmentation from step (A2) that is stored in a computer. As mentioned above, it is important to use existing segmentation results as the base for further segmentation so that the subsequent processes can be automated. Step (B3) is optionally modifying the target tooth arrangement for the entire orthodontic process from Taf to Tbf. In the following, Taf is modified to Tbf, but it should be appreciated that in other contemplated embodiments, Taf is not modified, and it remains target tooth arrangement for the entire orthodontic process. In Steps (B4)-(B7), steps (A4)-(A7) are repeated similarly mutatis mutandis. What is also important is that B4 will be based on the accomplished tooth segmentation and the approach in A4 to generate the intermediate series of datasets.

The term “mutatis mutandis” will be illustrated and explained in the following. As shown in FIG. 5, similar to step (A4) as described above, step (B4) is producing a second series of successive intermediate datasets Db2˜Db12 representing a second series of successive intermediate tooth arrangements Tb2˜Tb12. The second series of successive intermediate tooth arrangements progress from the second initial tooth arrangement Tb1 to the final tooth arrangement Tbf (via Tb2˜Tb12). The intermediate datasets and the final dataset Dbf each enables the fabrication of a second series of successive corresponding appliances PbS including Pb2˜Pb12 and Pbf. However, in step (B5), only a beginning portion Pb(S1) (including Pb2˜Pb6) of the second series of successive appliances PbS is or are fabricated. In step (B6), the appliances of the first beginning portion Pb(S1) (including Pb2˜Pb6) are applied as many as possible on the patient's teeth 10 (Tb1, Tb2, Tb3, Tb4, and Tb5 respectively). Similar to the first sub-process, the teeth 10 are repositioned in step (B7) to a second resultant tooth arrangement Tbr, through Tb2, Tb3 and Tb4. Also similar to the first sub-process, Pb5 cannot be applied on Tb4 anymore, since acceptable deviations have been accumulated to an unacceptable level.

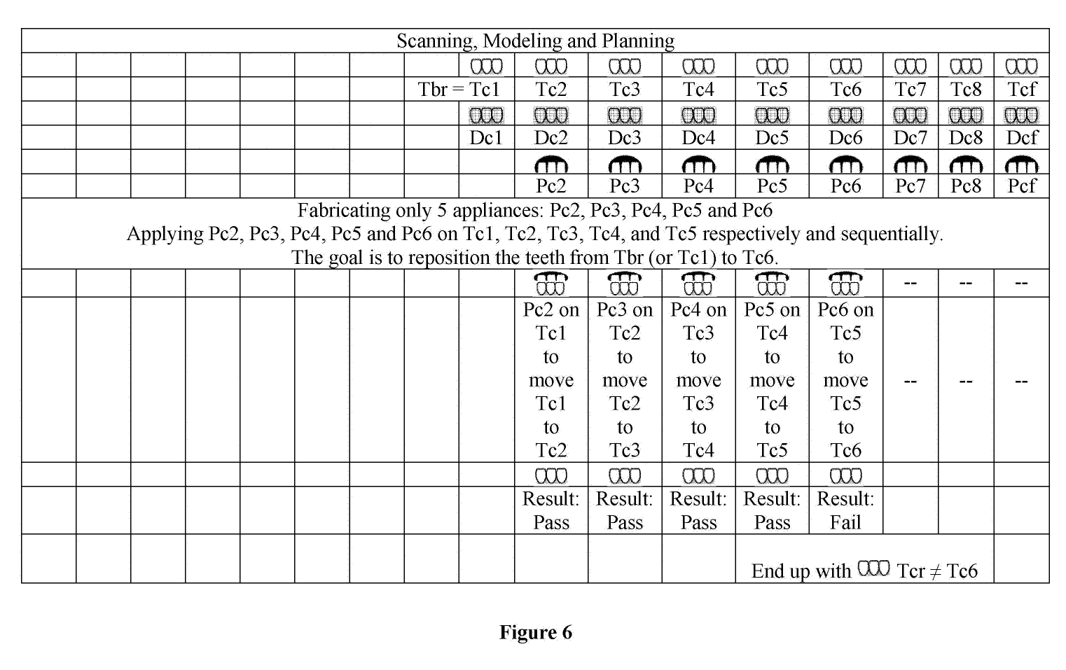

After Phase (B), one or more subsequent sub-processes are optionally executed by repeating the second sub-process similarly mutatis mutandis, until the teeth are repositioned to the target tooth arrangement Taf or any optionally modified target thereafter, e.g. Tbf, Tcf, Tdf, Tef, Tff, and so on. The term “mutatis mutandis” will be illustrated and explained in the following. As shown in FIG. 6, a third sub-process is executed in Phase (C). Step (C1) is scanning the second resultant tooth arrangement Tbr to provide a third geometric model 14c of the teeth 10. Then in step (C2), a third initial dataset Dc1 representing a third initial tooth arrangement Tc1 is produced by registering the scan from (C1) with tooth segmentation from step (A2) or (B2). Step (C3) is optionally modifying the target tooth arrangement for the entire orthodontic process from Tbf to Tcf. Steps (C4)-(C7) repeating steps (A4)-(A7) similarly mutatis mutandis. For details, step (C4) is producing a third series of successive intermediate datasets Dc2˜Dc8 representing a third series of successive intermediate tooth arrangements Tc2˜Tc8. Successive intermediate tooth arrangements of the third series progress from the third initial tooth arrangement Tel to the final tooth arrangement Tcf (via Tc2˜Tc8). The intermediate datasets and the final dataset Dcf each enables the fabrication of a third series of successive corresponding appliances PcS including Pc2˜Pc8 and Pef. However, only a beginning portion Pc(S1), for example, Pc2˜Pc6 of the third series of successive appliances PcS are fabricated in step (C5). Step (C6) is applying the appliances of the first beginning portion Pc(S1) (including Pc2˜Pc6) as many as possible on the patient's teeth 10 (Tc1, Tc2, Tc3, Tc4, and Tc5 respectively and sequentially). However, Pc5 cannot be applied on Tc4 anymore, since acceptable deviations have been accumulated to an unacceptable level. As a result, the teeth 10 are repositioned to a third resultant tooth arrangement Tcr through Tc2, Tc3 and Tc4, as summarized in step (C7).

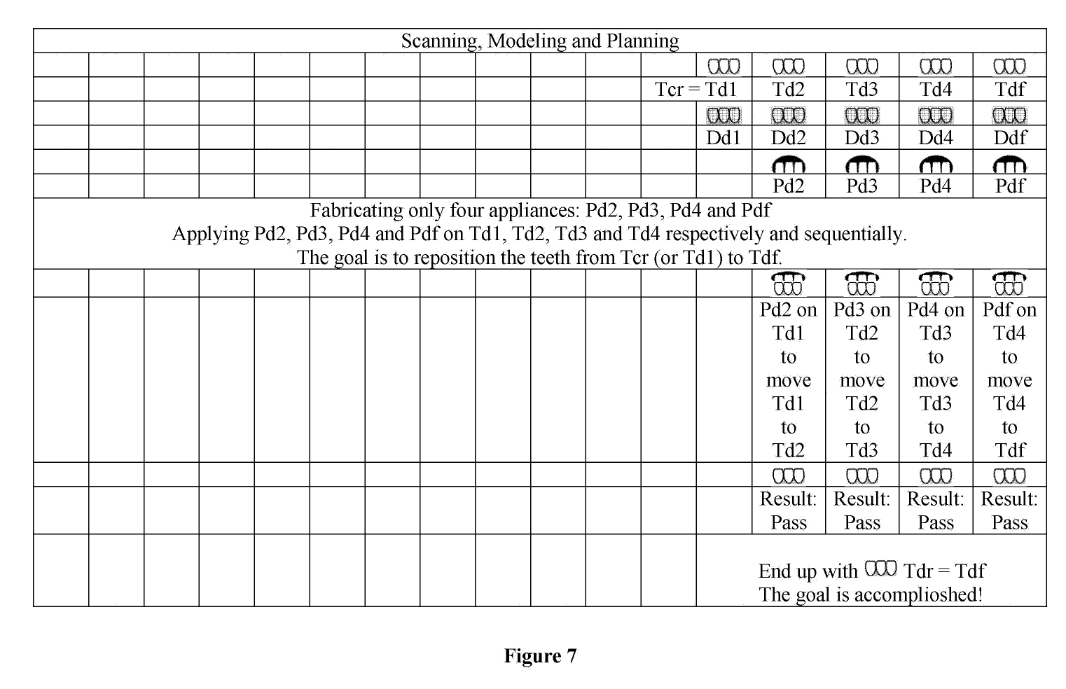

As shown in FIG. 7, executed in phase (D) is the fourth sub-process. In Step (D1), the third resultant tooth arrangement Tcr is scanned to provide a fourth geometric model 14d of the teeth 10. Step (D2) is producing a fourth initial dataset Dd1 representing a fourth initial tooth arrangement Td1 by registering the scan from (D1) with tooth segmentation from step (A2) or (B2) or (C2). The target tooth arrangement for the entire orthodontic process is optionally modified from Tcf to Tdf in step (D3). Once again, steps (D4)-(D7) are repeating steps (A4)-(A7) similarly mutatis mutandis. Specifically, step (D4) is producing a fourth series of successive intermediate datasets Dd2˜Dd4 representing a fourth series of successive intermediate tooth arrangements Td2˜Td4. The fourth series of successive intermediate tooth arrangements progress from the fourth initial tooth arrangement Td1 to the final tooth arrangement Tdf (via Td2˜Td4). The intermediate datasets and the final dataset Ddf each enables the fabrication of a fourth series of successive corresponding appliances PdS including Pd2˜Pd4 and Pdf. Unlike previous steps (A5), (B5) and (C5), all the fourth series of successive appliances PdS including Pd2˜Pd4 and Pdf are fabricated in step (D5). In step (D6), the appliances Pd2˜Pd4 and Pdf are applied on the patient's teeth 10 (Td1, Td2, Td3, and Td4 respectively and sequentially). Step (D7) summaries the result of this sub-process, i.e. repositioning the teeth 10 to a fourth resultant tooth arrangement Tdr through Td2, Td3 and Tc4). In this sub-process, Pdf can be successfully applied on Td4, since acceptable deviations have not been accumulated to an unacceptable level yet.

In the process of the invention, at least one of the above sub-processes can sometimes be used to resolve the situation (or to avoid remaking all aligners) where one or more corresponding appliances in said at least one sub-process cannot be applied to the teeth because acceptable deviations have been accumulated to an unacceptable level at some point, and the corresponding resultant tooth arrangement is not what the corresponding beginning portion is intended for. In other words, at least one of the following events occurs: Pa6 cannot be applied to Ta5 anymore; Pb5 cannot be applied on Tb4 anymore; Pc5 cannot be applied on Tc4 anymore.

In some embodiments of the invention, the beginning portion of a certain series of successive appliances includes less than half of the total successive appliances in said certain series or includes only one appliance. For example, only one appliance needs to be fabricated in the last sub-process. In other embodiments, the beginning portion of a series of successive appliances in each sub-process may always include only one appliance.

In some embodiments of the invention, the target tooth arrangement for the entire orthodontic process is never modified. In other embodiments of the invention, the target tooth arrangement for the entire orthodontic process is modified at least once. In still other embodiments, the target tooth arrangement for the entire orthodontic process is always modified in all the sub-process between the first sub-process and the last sub-process. In other words, the term “optionally” is embodied as “always”.

The invention is directed to an incremental process featured with dynamic dental planning as embodied in steps (A3)˜(A4), (B3)˜(B4), (C3)˜(C4), (D3)˜(D4), and so on. In prior art, the aligners are initially made according to a plan, and corrective stages are remade during the process, if necessary. In many cases, however, dental treatments may not follow the planned course, and as a result, the turnaround time becomes undesirably long if the appliances are designed and manufactured in a remote facility.

In embodiments of the above process, if all the sub-processes are executed as one integrated workflow at one facility, either the dental offices or service provider, it can be called centralized process. Otherwise, the process can be referred to as a distributed process. In a variety of exemplary embodiments, the orthodontic process of the invention may be implemented in two separate facilities, especially the initial sub-process is performed at a service provider's site, and the incremental sub-processes are carried out at the dental offices and the like. In other embodiments, the steps of scanning the teeth, incremental planning of the treatments, fabricating the appliances, and applying the appliances on the patient's teeth may be executed in one facility (hereinafter “Facility A” or “First Facility”) such as a dentist's office. The steps of segmenting the individual teeth, generating the final dataset, producing the series of successive intermediate datasets, and modifying the target tooth arrangement for the entire orthodontic process may be executed in another facility (hereinafter “Facility B” or “Second Facility”) such as a dental CAD/CAM service provider.

The advantage of this incremental planning is that once the service provider at facility B has performed the initial planning, the dental professionals at facility A can easily carry out the sub-processes in the incremental stage, because the tedious and hard work of segmentation, registration, tooth movements can be highly automatic in the incremental process.

An initial treatment plan is started at Facility A with the 3D scan of the patient's initial dental structure. The approach may be based on only optical scan of the teeth. As described in the above steps (A2) and (A3), the planning performed at Facility B generates the final tooth arrangement after segmenting the teeth and simulating the tooth movements.

In embodiments, aligners may be made incrementally at Facility A by monitoring the progress, comparing with the final status of the teeth and setting a stage goal. The dental professionals at Facility A do not make all the aligners when the treatment starts, and they don't need to change the desired final tooth status. They only need to run through the incremental planning process and make only a plurality of aligners for a treatment stage at any given time, as described in the above steps (A5), (B5), and (C5).

According to the present invention, the patient's tooth structure is rescanned for re-planning or dynamic planning during the treatment course. The resulted dataset may be registered with the final tooth arrangement and segmented using the segmentation in step (A2) as in the initial treatment plan. An intermediate goal of the treatment stage is defined. An embodiment can be to calculate the deviations between the new scan and the final scan, to determine how many steps are needed for correct all the teeth, and to decide to make aligners for, e.g. 3 steps. Then the stage models (i.e. intermediate tooth arrangements) for the aligners are made accordingly, as described in the above steps (A4), (B4), (C4) and so on. In a specific embodiment, a new scan will be obtained for the actual tooth status, a new incremental planning will be run, and an aligner will be made to for this stage.

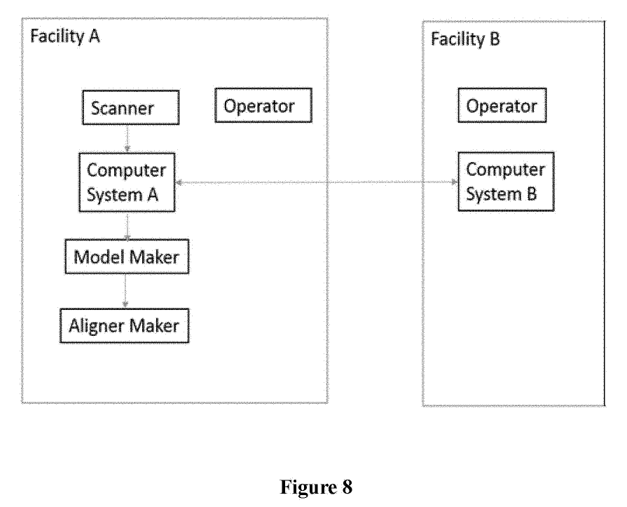

Another embodiment of the invention provides the manufacturing process and facility setup, for the implementation of the above incremental process. Referring to the example shown in FIG. 8, a doctor at Facility A may have access to a computer system, a scanner and a manufacturing equipment. A service provider at Facility B may have another computer system. They can be connected by internet or intranet. The doctor at Facility A sends the geometric model of the teeth to the service provider at Facility B, who will process the digital model and perform the initial treatment plan and send it back to the doctor at Facility A. At any time of the treatment, including the initial stage, the doctor at Facility A inputs the treatment plan and the current scan of the patient into a software system, which then generates a plurality of digital models to make aligners for the treatment stage. In this process, the treatment is always performed in an incremental way with no need to manual perform segmentation and registration of teeth. Models are not generated for the full course. The facilities are setup for both the initial and the incremental planning.

Before a treatment starts, the patient is scanned, and 3D dataset or the first geometric model are obtained for the dental structures, as described in the above steps (A1), (B1), (C1), and so on. This results in a geometric model with a plurality of teeth and adjacent soft tissue surfaces.

Referring to FIG. 8, in Facility A such as a dental office, a scanning means is used to obtain 3D images or geometric model of the dental structure. The scanning means can be an intra-oral scanner, a model scanner, or a third party service provider. A computer system A is used to process the patient data and treatment information, a model maker is employed to fabricate the staged models, and an aligner maker actually makes the aligners. In facility B, another computer system B performs the treatment plan and generates digital models.

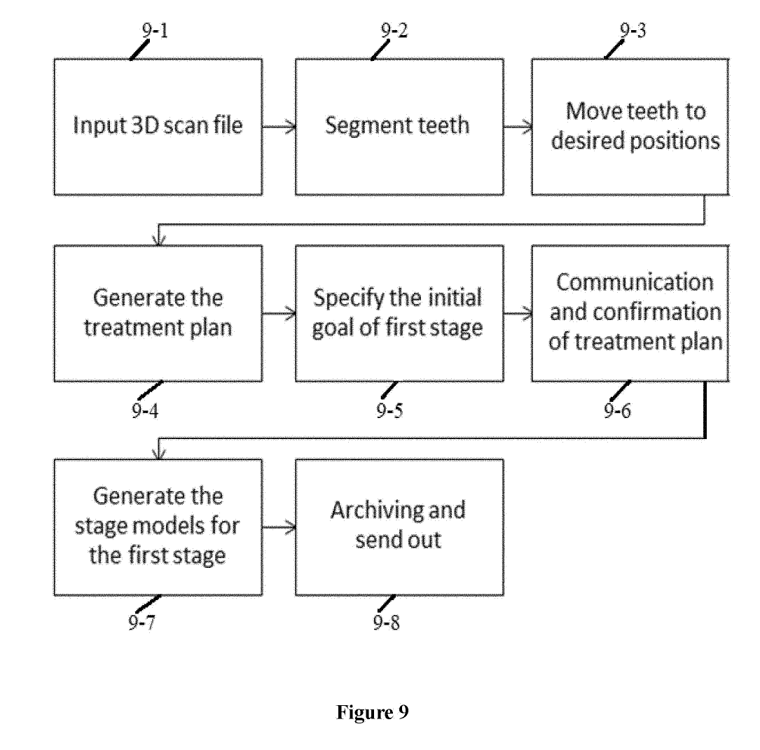

FIG. 9 shows the initial planning. At Facility B, the following steps are carried out: inputting 3D scan file; segmenting teeth; moving teeth to desired positions; generating a treatment plan; specifying the initial goal of first stage; communicating and confirming the treatment plan with the doctor at Facility A; generating the stage models for the first stage; and archiving the stage models and sending them out to the doctor at Facility A.

Once the treatment planning has been performed, the treatment plan will be communicated with the operator in Facility A. An embodiment is that a doctor or technician in facility B will provide all the segmentation and tooth planning services, and use web meeting to discuss and confirm the plan with the doctor or assistant in facility A.

Instead of generating all the staged models from beginning to the end, a key frame or status is chosen, which represents certain amount of the tooth movements. In a particular embodiment, for each tooth, the total movement is defined as a transformation matrix that has components for translations and rotations. One can simply define for example a percentage of the movement will be the goal of a treatment stage. The status corresponds to this stage is called a key frame. Examples of key frame may be Ta6, Tb6, Tc6, Tdr/Tdf, and so on. After the plan is approved, it will be transferred to computer A.

Another embodiment is that there is a data transferring and receiving means in computer system A and B. B sends data to A, and the operator of A will review the plan, adjust the desired tooth positions, and send back to B for further communication. Once the plan is done, the treatment data is synchronized in both computer systems.

Computer system A now will evaluate the initial positions of the teeth and their final positions. A software module in computer A will generate a plurality of stage models from the initial status to the key frame. In a particular embodiment, the selected frame is very close to the initial status and there is only one model for the key frame and none in between.

Now this plurality of models are exported to the model maker, typically a 3D printer. The 3D printer will print those stage models, and the operator will further on make aligners with the models by an equipment that can convert the stage models into negative models, which are the aligners. The aligners are given to the patient for treatment.

When the made aligners are all used, or before they are all used, the patient will go back to facility A. This starts the incremental planning and treatment stages. Another dataset will be obtained with the scanner. This results in a model that may or may not be corresponding to the initially planned key frame for said aligners.

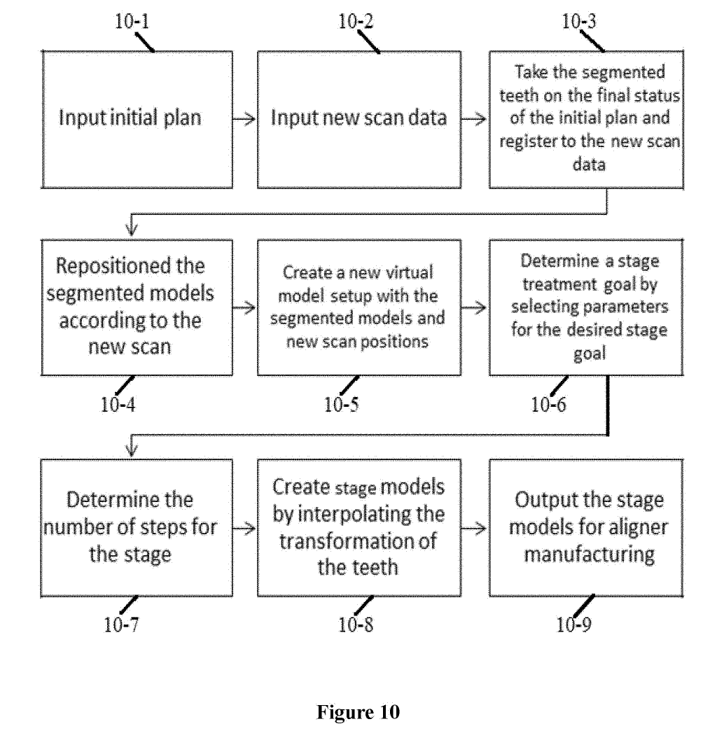

FIG. 10 shows the incremental planning at Facility A. The planning includes inputting initial plan; inputting new scan data; taking the segmented teeth on the final status of the initial plan and registering to the new scan data; repositioning the segmented models according to the new scan; creating a new virtual model setup with the segmented models and new scan positions; determining a stage treatment goal by selecting parameters for the desired stage goal; determining the number of steps for the stage; creating stage models by interpolating the transformation of the teeth; and outputting the stage models for aligner manufacturing.

In this writing, techniques and technologies may sometimes be described herein in terms of functional and/or logical block components, and with reference to symbolic representations of operations, processing tasks, and functions that may be performed by various computing components or devices. Such operations, tasks, and functions are sometimes referred to as being computer-executed, computerized, processor-executed, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or executable instructions that, when executed by one or more processor devices, cause the host computing system to perform the various tasks. In certain embodiments, the program or code segments are stored in a tangible processor-readable medium, which may include any medium that can store or transfer information. Examples of suitable forms of non-transitory and processor-readable media include an electronic circuit, a semiconductor memory device, a ROM, a flash memory, an erasable ROM (EROM), a floppy diskette, a CD-ROM, an optical disk, a hard disk, or the like.

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in the specific form in which such claims issue, including any subsequent correction.

1. An orthodontic process phased into two or more sub-processes for repositioning a patient's teeth comprising:
(A) executing a first sub-process which includes:
(A1) scanning the teeth to provide a first geometric model of the teeth;
(A2) segmenting the teeth in the first geometric model individually to produce a first initial dataset representing a first initial tooth arrangement;
(A3) generating a final dataset representing a final tooth arrangement for an entire orthodontic process;
(A4) producing a first series of successive intermediate datasets representing a first series of successive intermediate tooth arrangements, wherein said first series of successive intermediate tooth arrangements progress from said first initial tooth arrangement to said final tooth arrangement, wherein the intermediate datasets and the final dataset enables a fabrication of a first series of successive appliances;
(A5) fabricating a first beginning portion of the first series of successive appliances;
(A6) applying appliances of said first beginning portion on the teeth; and
(A7) repositioning the teeth to a first resultant tooth arrangement; and
(B) executing a second sub-process which includes:
(B1) scanning the first resultant tooth arrangement to provide a second geometric model of the teeth;
(B2) segmenting individual teeth to produce a second initial dataset representing a second initial tooth arrangement by registering scan from (B1) with tooth segmentation from step (A2), wherein tooth segmenting performed in step (A2) is used as a base for executing said segmenting in step (B2);
(B3) producing a second series of successive intermediate datasets representing a second series of successive intermediate tooth arrangements, wherein the second series of successive intermediate tooth arrangements progress from the second initial tooth arrangement to the final tooth arrangement from step (A3); wherein said second series of successive intermediate datasets and the final dataset enable a fabrication of a second series of successive appliances;
(B4) fabricating only a beginning portion of the second series of successive appliances;
(B5) applying the appliances of the beginning portion from step (B4) on the patient's teeth;
(B6) repositioning the teeth to a second resultant tooth arrangement; and
(C) executing one or more sub-processes, until the teeth are repositioned to said final tooth arrangement in step (A3).

2. The orthodontic process according to claim 1, wherein said beginning portion of a series of successive appliances includes less than half of the total successive appliances in said series, or includes only one appliance.

3. The orthodontic process according to claim 1, wherein said beginning portion of a series of successive appliances in each sub-process only correct tooth positions from one planned tooth arrangement to the next.

4. An orthodontic process phased into two or more sub-processes for repositioning a patient's teeth comprising:
(A) executing a first sub-process which includes:
(A1) scanning the teeth to provide a first geometric model of the teeth;
(A2) segmenting the teeth in the first geometric model individually to produce a first initial dataset representing a first initial tooth arrangement;
(A3) generating a final dataset representing a final tooth arrangement for an entire orthodontic process;
(A4) producing a first series of successive intermediate datasets representing a first series of successive intermediate tooth arrangements, wherein said first series of successive intermediate tooth arrangements progress from said first initial tooth arrangement to said final tooth arrangement, wherein the intermediate datasets and the final dataset enable the fabrication of a first series of successive appliances;
(A5) fabricating a first beginning portion of the first series of successive appliances;
(A6) applying appliances of said first beginning portion on the teeth; and
(A7) repositioning the teeth to a first resultant tooth arrangement; and
(B) executing a second sub-process which includes:
(B1) scanning the first resultant tooth arrangement to provide a second geometric model of the teeth;
(B2) segmenting individual teeth to produce a second, initial dataset representing a second initial tooth arrangement by registering the scan from (B1) with tooth segmentation from step (A2), wherein tooth segmentation performed in step (A2) is used as a base for executing said segmenting in step (B2);
(B3) modifying the final tooth arrangement for the entire orthodontic process and registering the tooth arrangement of step (B1) to the modified final tooth arrangement;
(B4) producing a second series of successive intermediate datasets representing a second series of successive intermediate tooth arrangements, wherein the second series of successive intermediate tooth arrangements progress from the second initial tooth arrangement to the final tooth arrangement from step (A3); wherein said second series of successive intermediate datasets and the final dataset enable a fabrication of a second series of successive appliances;
(B5) fabricating only a beginning portion of the second series of successive appliances;
(B6) applying appliances of the beginning portion from step (B5) on the teeth;
(B7) repositioning the teeth to a second resultant tooth arrangement; and
(C) executing one or more sub-processes, until the teeth are repositioned to a final tooth arrangement.

5. The orthodontic process according to claim 4, wherein the final tooth arrangement for the entire orthodontic process is always modified in the sub-process (B) and said one or more sub-processes.

6. The orthodontic process according to claim 1, wherein the appliance is an aligner.

7. The orthodontic process according to claim 4,
wherein steps (A1) and (B1); steps (A5) and (B5); and steps (A6) and (B6) are executed in a first facility; and
wherein steps (A2) and (B2); steps (A3) and (B3); and steps (A4) and (B4) are executed in a second facility.

8. The orthodontic process according to claim 7, wherein the first facility is a dentist's office, and the second facility is a dental service provider.

9. The orthodontic process according to claim 4,
wherein steps (A1) and (B1); and steps (A6) and (B6) are executed in a dentist's office; and
wherein steps (A2) and (B2); steps (A3) and (B3); steps (A4) and (B4); and steps (A5) and (B5) are executed in a dental service provider.

10. The orthodontic process according to claim 4, wherein steps B2, B3 and B4 are automated.

11. The orthodontic process according to claim 1, wherein said scanning is optical scanning only.

12. A distributed CAD/CAM process phased into two or more sub-processes for repositioning a patient's teeth comprising:
(a) executing a first sub-process at one facility which includes:
(a1) receiving a first geometric model of the teeth generated by scanning the patient's teeth in a dental office;
(a2) segmenting individual teeth to produce a first initial dataset representing a first initial tooth arrangement;
(a3) generating a final dataset representing a final tooth arrangement for an entire orthodontic process;
(a4) producing a first series of successive intermediate datasets representing a first series of successive intermediate tooth arrangements, wherein said first series of successive intermediate tooth arrangements progress from said first initial tooth arrangement to said final tooth arrangement, wherein the intermediate datasets and the final dataset enables a fabrication of a first series of
successive appliances; and
(a5) delivering the first series of successive intermediate datasets and the final dataset back to the dental office, and fabricating only a beginning portion of the first series of successive appliances;
(b) executing a second sub-process which includes:
(b1) receiving a second geometric model of the teeth generated by scanning the first resultant tooth arrangement in the dental office;
(b2) producing a second initial dataset representing a second initial tooth arrangement by registering the scan in (b1) with tooth segmentation from step (a2);
(b3) producing a second series of successive intermediate datasets representing a second series of successive intermediate tooth arrangements, wherein the second series of successive intermediate tooth arrangements progress from the second initial tooth arrangement to the final tooth arrangement from step (a3); wherein said second series of successive intermediate datasets and the final dataset enable a fabrication of a second series of successive appliances;
(b4) fabricating only a beginning portion of the second series of successive appliances;
(b5) applying the appliances of the beginning portion from step (b4) on the teeth;
(b6) repositioning the teeth to a second resultant tooth arrangement;
and
(c) executing one or more sub-processes, until the teeth are repositioned to said final tooth arrangement in step (a3).

13. The distributed CAD/CAM process according to claim 12, wherein the first beginning portion of the first series of successive appliances is fabricated in the dental office;

14. The distributed CAD/CAM process according to claim 12, wherein said beginning portion of a series of successive appliances includes less than half of the total successive appliances in said series, or includes only one appliance.

15. The distributed CAD/CAM process according to claim 12, wherein said beginning portion of a series of successive appliances in each sub-process move teeth only by one step as planned.

16. A distributed CAD/CAM process phased into two or more sub-processes for repositioning a patient's teeth comprising
(a) executing a first sub-process at one facility which includes:
(a1) receiving a first geometric model of the teeth generated by scanning the patient's teeth in a dental office;
(a2) segmenting individual teeth to produce a first initial dataset representing a first initial tooth arrangement;
(a3) generating a final dataset representing a final tooth arrangement for an entire orthodontic process;
(a4) producing a first series of successive intermediate datasets representing a first series of successive intermediate tooth arrangements, wherein said first series of successive intermediate tooth arrangements progress from said first initial tooth arrangement to said final tooth arrangement, wherein the intermediate datasets and the final dataset enable a fabrication of a first series of successive appliances; and
(a5) delivering the first series of successive intermediate datasets and the final dataset back to the dental office, and fabricating only a beginning portion of the first series of successive appliances;
(b) executing a second sub-process which includes:
(b1) receiving a second geometric model of the teeth generated by scanning the first resultant tooth arrangement in the dental office;
(b2) producing a second initial dataset representing a second initial tooth arrangement by registering the scan in (b1) with tooth segmentation from step (a2);
(b3) modifying the final tooth arrangement for the entire orthodontic process and registering the tooth arrangement of step (b1) to the modified final tooth arrangement;
(b4) producing a second series of successive intermediate datasets representing a second series of successive intermediate tooth arrangements, wherein the second series of successive intermediate tooth arrangements progress from the second initial tooth arrangement to the final tooth arrangement from step (a3); wherein said second series of successive intermediate datasets and the final dataset enable the fabrication of a second series of successive appliances;
(b5) fabricating only a beginning portion of the second series of successive appliances;
(b6) applying the appliances of the beginning portion from step (b5) on the teeth;
(b7) repositioning the teeth to a second resultant tooth arrangement; and
(c) executing one or more sub-processes, until the teeth are repositioned to a final tooth arrangement.

17. The distributed CAD/CAM process according to claim 16 claim 12, wherein the final tooth arrangement for the entire orthodontic process is modified in said one or more sub-processes.

18. The distributed CAD/CAM process according to claim 12, wherein the appliance is an aligner.

19. The distributed CAD/CAM process according to claim 12, wherein the scanning is optical scanning only.

20. A centralized CAD/CAM process phased into two or more sub-processes for repositioning a patient's teeth comprising:
(I) executing a first sub-process which includes:
(I-1) receiving a first geometric model of the teeth generated by scanning the teeth in a dental office;
(I-2) segmenting the teeth to produce a first initial dataset representing a first initial tooth arrangement;
(I-3) generating a final dataset representing a final tooth arrangement for an entire orthodontic process;
(I-4) producing a first series of successive intermediate datasets representing a first series of successive intermediate tooth arrangements, wherein said first series of successive intermediate tooth arrangements progress from said first initial tooth arrangement to said final tooth arrangement, wherein the intermediate datasets and the final dataset enables a fabrication of a first series of successive appliances; and
(I-5) fabricating a first beginning portion of the first series of successive appliances, which are delivered to the dental office so that the appliances of said first beginning portion are applied on the teeth; and the teeth are repositioned to a first resultant tooth arrangement;
(II) executing a second sub-process which includes:
(II-1) receiving a second geometric model of the teeth generated by scanning the first resultant tooth arrangement in the dental office;
(II-2) producing a second initial dataset representing a second initial tooth arrangement by registering the scan in (II-1) with tooth segmentation from step (I-2);
(II-3) optionally modifying the final tooth arrangement for the entire orthodontic process and registering the tooth arrangement of step II-1 to such modified final tooth arrangement
(II-4) producing a second series of successive intermediate datasets representing a second series of successive intermediate tooth arrangements, wherein the second series of successive intermediate tooth arrangements progress from the second initial tooth arrangement to the final tooth arrangement from step (I-3); wherein said second series of successive intermediate datasets and the final dataset enable a fabrication of a second series of successive appliances;
(II-5) fabricating only a beginning portion of the second series of successive appliances;
(II-6) applying appliances of the beginning portion from step (II-5) on the teeth;
(II-7) repositioning the teeth to a second resultant tooth arrangement; and
(III) executing one or more sub-processes, until the teeth are repositioned to said final tooth arrangement in step (I-3) or a modified final tooth arrangement.
